(19) United States
(12) Patent Application Publication
(10) Pub. No.: US 2010/0023527 A1
(43) Pub. Date: Jan. 28, 2010

(54) PROVIDER-CONSUMER WEB PORTAL

(76) Inventors: Paul E. Kleinschmidt, Vass, NC (US); Joshua Hinman, Los Angeles, CA (US); Scott C. Helf, Corona, CA (US); Sean M. Siler, Southern Pines, NC (US); Simon Chelebyan, Reseda, CA (US)

Correspondence Address: MCKENNA LONG & ALDRIDGE LLP, 1900 K STREET, NW, WASHINGTON, DC, 20006, US

(21) Appl. No.: 12/489,407

(22) Filed: Jun. 22, 2009

Related U.S. Application Data
(60) Provisional application No. 61/074,575, filed on Jun. 20, 2008.

(51) Int. Cl. G06F 17/30

(52) U.S. Cl. 707/10; 707/E17.001

(57) ABSTRACT

A system, comprising a processor, a database, a memory, and a communications interface, all operationally coupled to the processor, wherein the memory stores instructions that, when executed by the processor, cause the processor to receive data associated with a unique data value representative of an identification of a first service provider, and multimedia data, associated with the unique data value, confirm that the service provider identified by the unique data value is a registered service provider, and store the data in the database for later access by a consumer.

This application claims priority to U.S. Provisional Patent Application No. 61/074,575, filed Jun. 20, 2008, the contents of which are incorporated herein in its entirety.

### TECHNICAL FIELD

This application relates to an Internet-based portal configured to receive data from vetted service providers, and post, for consumer use, the data in various formats.

### BACKGROUND

There are over one billion annual outpatient visits in the United States alone. Eighty percent of all Internet users search for medical information online. Nearly ninety-five percent of physicians use the Internet regularly. A study conducted for the American Academy of Dermatology found that 67% of patients preferred to go online to research a medical procedure, yet fully 70% also said that their physician's advice was the ultimate decision-making factor.

One of the cornerstones in practice of medicine is education. It serves not only to inform patients about specific conditions, but to also teach key principles of disease prevention. However, patient education is time and resource intensive. As managed care and increasing patient loads are reducing the amount of face-to-face interaction, providers are finding themselves unable to accurately and efficiently provide enough education. Healthcare providers often explain the same concepts to patients, 5-10 times a day. Their support staff members are delivering routine and repetitive information multiple times a day regarding practice policies, directions, and administrative instructions.

### SUMMARY

The present invention provides a system and method for an Internet-based portal that obviates one or more of the aforementioned problems due to the limitations of the related art.

### Technical Problem

Increasingly, physicians and patients are turning to the Internet for help. However, the quality of information obtained from the Internet can be dubious in many cases. Statistics indicate that only one-quarter of consumers seeking on-line health advice follow any system for checking the source and timeliness of information when they go online for medical information. In fact, the Pew Research Foundation noted that consumers check food labels more often than they check the source and date of health information online.

Over 60% percent of physicians feel the need to share web sites designed for professionals with patients. They see this as a better alternative to many of the unreliable sites on the Internet. Yet websites designed for professional healthcare providers are not written in language that is easily, if at all, understandable by a layperson. In many instances, websites designed for professional healthcare providers are written in hyper-technical form, and as such, would be of no value to a layperson.

Moreover, it was noticed by the inventors that, if a web site desired to verify that a potential content provider was indeed a registered or licensed professional, that the web site required the user to enter identification information that corresponded exactly to the information already possessed by the website. Thus, if the website's information had a spelling error in a name, the potential content provider would be unable to post without having to mail credentials to the web site administrator and perform other acts to verify their identity and qualifications. An example of such a site is Webscape.com. Use of such a site was often so difficult to practitioners, due to simple misspellings in the database used by the website, that the practitioners grew frustrated and simply chose not to post content. The lack of a non-frustrating vetting procedure results in a barrier to the dissemination of information. The barrier is raised because frustration with the registration/vetting process discourages content providers from placing their valuable information in the Internet.

Patients want detailed medical information about their conditions, but the medical information should be provided at a level that the patient understands. Patients also want to take an active part in their care. Despite providing instructions during an office or hospital visit, even when successfully delivered by their provider, instructions are often misplaced if written, or forgotten if spoken, especially by elderly patients and by patients on certain medications. Studies have demonstrated that computerized presentations with audiovisual components are effective and that patients even had significantly improved knowledge about their condition one month later. An additional problem exists in that caregivers not at the original office or hospital visit are unfamiliar with verbal instructions given by the healthcare provider.

Patients who do not have a mastery of the English language are at risk for misinterpretation of medical instructions. These patients all require extra effort and multiple methods to safely deliver medical instructions, yet most healthcare practices cannot afford the time or resources to identify and accommodate them. When patients cannot learn from their provider, they turn to less reliable sources such as their friends, the media, and the Internet.

Of the twenty percent of Americans who do not turn to the Internet for medical advice, fully one-third cite a lack of trust in the information as a factor, and one-quarter state they don't know where to start looking for such information. Today's healthcare practices are facing a battle between patient education, practice efficiency, and patient satisfaction, and they are losing on all fronts. To quote the CEO of the American College of Physicians—“the current episodic patient care model does not support patient-centered, physician-guided, cost-efficient, longitudinal care that encompasses and values both the art and science of medicine.”

The Joint Commission lists, as one of their National Patient Safety Goals, to “improve patient involvement and education regarding their medical conditions.” This safety goal evidences a long felt but yet unfulfilled need of both healthcare professionals and patients.

### Solution to Problem

To the inventors' knowledge, the concept of using an Internet portal for posting, exclusively by vetted professionals such as medical doctors, of video and multi-media content is unique in the health care field, when done entirely by vetted practicing professionals.

To solve the above-mentioned problem, a method of vetting persons who propose to post information on a healthcare-related website is needed. Confirmed healthcare professionals can deliver medical content and instructions to patients outside of the traditional face-to-face office or hospital room environment as needed. Only vetted healthcare professionals should be permitted to store content on the healthcare-related website. Such information would then be available for access by users with knowledge of a unique identification code assigned to the vetted, or otherwise confirmed, healthcare professional. The users, who are patients, can be confident that the information they are receiving is approved, or even created, by their own healthcare provider. Of course, the systems and methods described herein are not restricted to the health care field. The systems and methods described herein are applicable at least to all professional fields of employment that license or otherwise regulate their practitioners. A system operating in accordance with methods described herein is also needed.

### Advantageous Effects of Invention

While the features and advantages of the disclosed embodiments are described in terms that relate to a medical practice setting, it will be understood that the invention described herein is applicable to most any professional field, such as dentistry, veterinary medicine, accounting, law, nursing, or any group capable of being identified by, and vetted through, data in a database. An example of such a database may be the NPI database, which will be described later.

Practicing the invention as disclosed in the exemplary embodiments described herein results in multiple advantageous effects. Examples of at least some of these advantageous effects are provided below. The list of advantageous effects is not meant to be exclusive or limiting. Rather, the list is exemplary. Moreover, the exemplary advantageous effects listed need not be realized simultaneously; they may be realized singularly or in any combination. Nor must any of the following effects be realized at all. As stated, the following list is not meant to be exclusive or limiting. Advantages other than those listed may be realized by the practice of the invention. Examples of at least some advantageous effects include the following:

Practice of the invention may result in reinforcement of key medical concepts in a scope beyond the average thirty minutes of face-to-face time patients spend with doctors annually.

Practice of the invention may allow delivery of content, felt to be important to a consumer's service provider, to the consumer out of a formal office setting and at the consumer's own time and choosing. Moreover, by posting their own educational information, a service provider might extend their practice standards and “face-time” with each consumer, outside the office setting. Furthermore, each service provider is free to address the specific needs of individual consumers by posting content for specific consumers, or classes of consumers, on his own site. Posted material may include material that provides interactive teaching.

Practice of the invention may permit a multiplying effect to be realized in consumer education. For example, it is estimated that the integration of the inventive concept into a medical practice may triple the education time given to a consumer by his provider per year while simultaneously shortening patient in-office cycle time. These two metrics, patient education time and in-office cycle time, are not customarily inversely proportional.

Practice of the invention may empower consumers with trusted information that has been screened or prepared by their service provider. For example, medical patients would prefer to receive medical information from their trusted physician, rather than receiving it from an unknown, sometimes anonymous, source on the Internet.

On conventional Internet sites of today, advice on any subject is available, yet that advice may come from a source that is not licensed in the field of which he is providing advice, not vetted by the web site owner, not held to a standard of a common licensing or regulatory authority, possibly fraudulent, and possibly unreliable. A consumer faced with a choice between obtaining advice from a vetted professional, regardless of whether the professional is the consumer's own service provider or another vetted professional, may be emotionally empowered to take and use the advice to his or her benefit. For example, practice of the invention may empower patients by giving them the knowledge and confidence that they can go to a website that only posts content from vetted medical practitioners, read about an illness, and learn how to deal with it effectively. Furthermore, the patient may feel a sense of confidence in the information provided, knowing that the content was prepared by either his or her own service provider or a similarly vetted service provider.

Practice of the invention, as stated above, may extend educational contact time between consumer and service provider, by allowing the consumer to access video, audio, and other formats through a web-based interface. The interface may provide a modern and attractive storefront at no cost to the consumer or to the service provider. Moreover, as the entity practicing the system and method of the invention will likely not be the service provider herself, the service provider may not need to manage her own web site. This results in cost and time savings for the service provider. Additional benefits may be realized by the service provider in that, in general, the operation of the web site may allow casual web users to obtain educational content by viewing “open” (non-secured) collections of the postings by individual providers, while giving the provider visibility for their own business or practice. Because a casual web user may search the “open” (non-secured) collections for content by, for example, specialty, title, and/or by geographic location of the provider who posted the information, the site naturally acts to draw consumers to providers that seem most suited to fit their needs.

As will be described in more detail, at least one embodiment of the invention may be realized on an Internet website, which is accessible to any consumer with access to the Internet. Thus, practice of the invention may provide both the specifically referred consumer (e.g., a patient) and the casual web consumer with multimedia educational experiences written entirely by vetted professionals. Thus, in one embodiment, consumers may be given the opportunity to view their own provider's instructions, in addition to core content accessible by all consumers visiting the website.

In one embodiment, the content present on a server, may be conceptually divided into multiple “private sites.” These private sites may be more or less unique to the service providers' own practice. Practice of the invention permits a service provider to screen, post, and create content. In this way, each respective service provider may be sure that his own site reflects his own practices and values.

Practice of the invention may allow a consumer to communicate with their service provider asynchronously, at the consumer's convenience. In one embodiment, a consumer may search for his provider's library of information, by using an identifier that uniquely identifies his service provider. Alternatively, a consumer may search for a particular instruction or posting, prepared or authorized by his provider, by using an identifier that uniquely identifies the instruction or posting.

By way of an example via an exemplary application of the system and method to the medical field, practice of the invention may permit caregivers, family, and friends, who were not at an office visit, to see and/or hear the same patient care instructions, at different times, according to their own schedules. The feature of permitting different persons, at different locations and different times to see an/or hear the instructions provided for the care of a patient may both ensure consistency of treatment and involve the various caregivers in the patient's care.

The advantages of the invention as claimed will be realized and attained by the exemplary method and structure described in the written description and illustrated in the appended drawings. It is to be understood that both the foregoing general description and the following detailed description are exemplary, explanatory, and non-limiting. They are intended to provide explanation of the invention as claimed.

### BRIEF DESCRIPTION OF THE DRAWINGS

FIG. 1 is a block diagram of a system in accordance with an embodiment of the invention.

FIG. 2 is flow diagram of a method, useful for a service provider, in accordance with an embodiment of the invention.

FIG. 3 is flow diagram of a method, useful for a consumer, in accordance with an embodiment of the invention.

FIG. 4 is a flow diagram of a method of rating content in accordance with an embodiment of the invention.

FIG. 5 is a flow diagram of a method of vetting user credentials according to an embodiment of the invention.

FIG. 6 is a flow diagram of a method of downloading and preprocessing data from a third party database according to an embodiment of the invention.

### DETAILED DESCRIPTION OF THE EMBODIMENTS

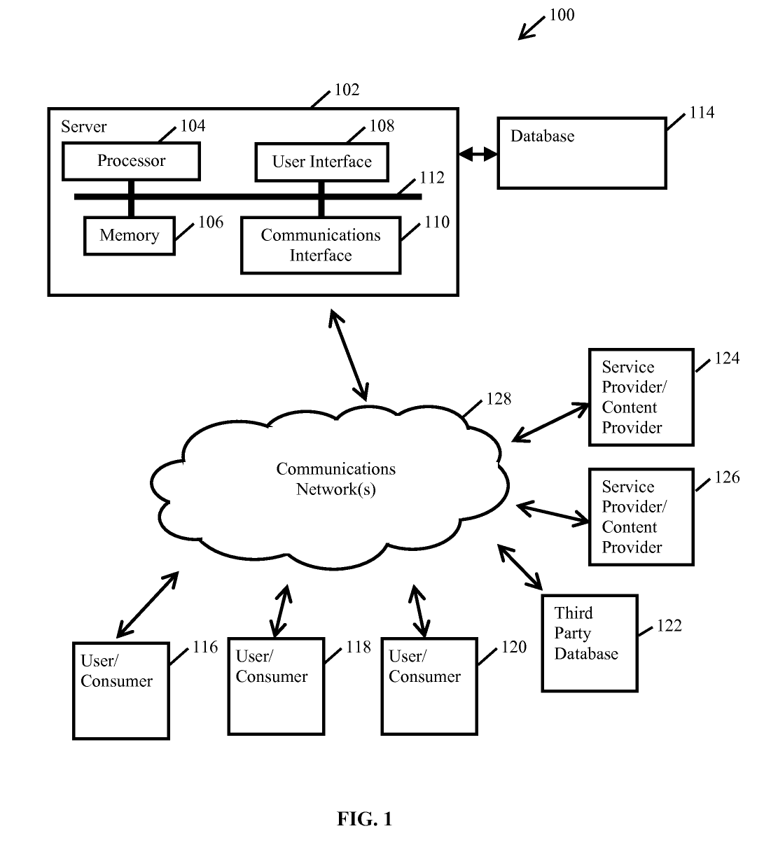

FIG. 1 is a block diagram of a system 100 in accordance with an embodiment of the invention. The system 100 includes a server 102, which includes a processor 104, a memory 106, a user interface 108, a communications interface 110 and a communications bus 112 that may have each of said items coupled thereto. The server 102 may be operationally coupled to a database 114. Of course, the database 114 may reside in a memory, such as memory 106. Thus, the database 114 may be remote or local to the server.

The server 102 may be operationally coupled to one or more communication networks 128, such as the Internet or the public switched telephone network (PSTN), via the communications interface 110. Also operationally coupled to the communication network(s) 128 may be the user equipment of one or more consumers 116, 118, 120. Also operationally coupled to the communication network(s) 128 may be the user equipment of one or more service providers 124, 126. Also operationally coupled to the communication network(s) 128 may be a third party database 122, which will be described later. Service providers 124, 126 may include physicians, physician assistants, dentists, lawyers, physical therapists, psychologists, chiropractors, nurse practitioners, midwives, and other licensed professionals. In general, service providers can belong to any group whose members' identities are recorded in a database as a class of licensed professionals. Consumers 116, 118, 120 may include patients of a medical or dental practice, clients of a legal practice, clients of therapists, psychologists, chiropractors, nurse practitioners or midwives. In general, consumers may include any persons or classes of people who make use of the services provided by the service providers.

In practice, a third party database 122 may include a copy of, or be an original of, a catalog of the identities of a group of service providers, where the members of the group of service providers are held to some common standard, such as a standard of care. Achievement of at least the ability of the members to meet the standard of care may be determined by a licensing authority. For attorneys, for example, the licensing authority may be a state bar organization. For physicians, the licensing authority may be the Government agency that oversees the medical boards. To attain membership in a particular group, a prospective candidate might need to take a test to prove that he or she can provide service at a level that is at least equivalent to the standard of care established for the group of service providers. Once a prospective candidate is accepted into the group, information about the identity of the new member may be stored in a database or memory, similar to the database 114, 122, or memory 106 of FIG. 1.

An example of a third party database 122 is a database that includes information related to health care providers according to each heath care provider's National Provider Identifier (NPI). The NPI provides a unique identifier for each health care provider in the health care system of the United States. It shall be understood that while the NPI is a government-managed database, the invention is not limited to the use of data stored in, or compiled by, any government agency.

One notable feature of the embodiments described herein, comprises the process by which service providers are vetted, prior to their being given full authorization to store data on the memory 106 or database 114 of the system 100. A service provider may register for permission to post data to a site in accordance with an embodiment of the invention. As a part of the process of registration, the processor 104 may execute code stored in the memory 106. The code may cause the processor 104 to compare data input by a prospective service provider with data stored in the database, such as the NPI database. If the data matches to a predetermined degree, then the prospective user is “vetted” and henceforth may be known as a vetted service provider. Using NPI as an example, the information contained therein not only identifies the individual associated with the data, but also identifies the individual as a member of a group of persons that having special qualifications (for example, all medical practitioners that have passed the National Boards). Once vetted, a service provider might post to a site designated just for that service provider, whatever information, in whatever form, the service provider finds useful.

Another notable feature is the ability of the system to account for, and attempt to resolve, errors in, for example, spelling of service providers' names. This feature permits a service provider to interact with the website, to get authorization to post on the website, without frustration encountered elsewhere. It also permits a service provider to post information, even if the automated vetting process cannot accommodate the spelling differences. In such a case, the permission to post is provisional, and the final authorization rests in a first action being taken by a web site administrator.

Another notable feature of the embodiments described herein relates to the ongoing review of content posted by any one service provider. In one embodiment, consumers may critique or otherwise rate the content of a given service provider. Simultaneously, but separately, other service providers may critique or otherwise rate the content of the given service provider. The processor, in accordance with one embodiment, continually calculates the average rating the given service provider for each of the two classes of critics. The processor may also compare the average values of ratings of the two classes of critics and provide information that could inform both consumers and service providers of the degree of similarity between the opinions of the two classes. For example, given a scale of 1 to 10, with 10 being the best, the class of consumer critics might rate a given service provider's content as a 8, while the class of service provider critics might rate the content as a 6. The average of the two ratings would be 7 and the difference between the two ratings would be 2. For a second service provider having similar content, the class of consumer critics might rate the second service provider's content as a 7, while the class of service provider critics might also rate the content as a 7. The average of the two ratings would be 7 and the difference between the two ratings would be 0. The data and other statistics may be calculated and presented by the processor to the consumer or service provider. The calculation and presentation may be performed continuously, periodically, or on a demand basis, by the processor 104. Consumers and service providers would be free to draw their own opinions based on the data. Other statistics may also be calculated and displayed by the processor.

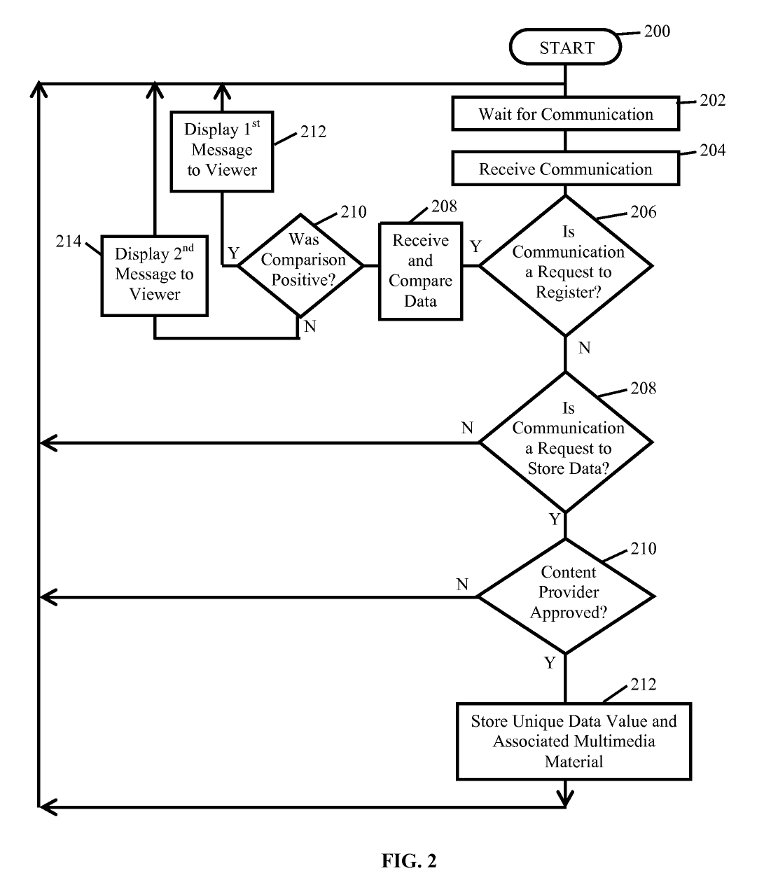

FIG. 2 is a flow diagram of a method, useful for service providers, in accordance with an embodiment of the invention. The method of FIG. 2 may begin at 200. At 202, the processor may wait to receive communication from, for example, communications interface 110 via communications bus 112. At 204, a communication may be received. At 206, if the communication is a request to register as a service provider, the method may proceed to 208. At 208, registration data provided by the prospective provider may be received by the processor and compared to data in a database (such as 114, 122) that holds information related to members of a group, such as a group of heath care providers. In one embodiment, each member of the group is identified by a unique identifier, such as an NPI number. At 210, if the data received by the processor matches the data in the database to a predefined degree, then at 212, the method may cause a confirmation of registration message to be displayed on a user interface of the prospective service provider, now an actual service provider. If, at 210, the data received by the processor does not match the data in the database to a predefined degree, then at 214, the method may cause a failure of registration message to be displayed on a user interface of the prospective service provider.

Returning to 206, if the communication was not a request to register, then the method may continue to 208. At 208, if the communication was not a request to store data, then the method may return to 202. If the method is a request to store data, the method may proceed to 210, where the system may check to see if the service provider is registered or otherwise approved for posting content. If the service provider is registered, the method may proceed to 212 where the service provider may store any multimedia data. After storage of the data is completed, the method may return to 202.

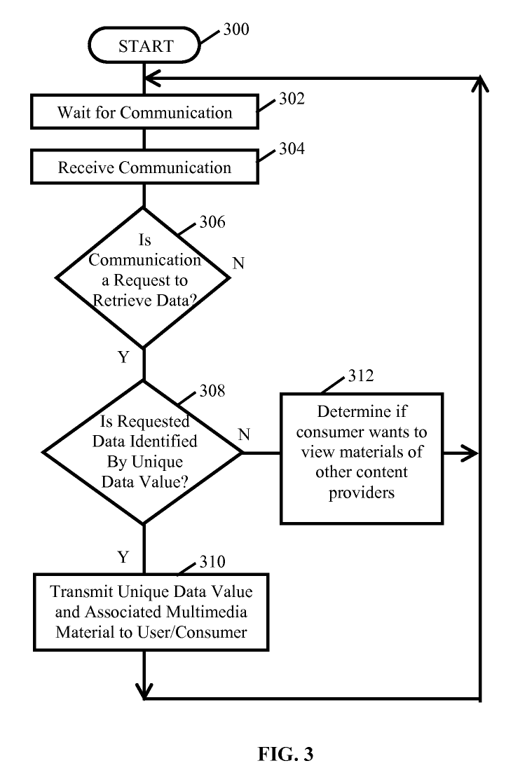

FIG. 3 is a flow diagram of a method, useful for consumers, in accordance with an embodiment of the invention. The method of FIG. 3 may begin at 300. At 302, the processor may wait to receive communication from, for example, communications interface 110 via communications bus 112. At 304, a communication may be received. At 306, if the communication is a request to retrieve data, the method may proceed to 308. At 308, it may be determined if the requested data is identified by a unique data value, for example, by a unique value associated with a single content provider or a unique value associated with specific content posted by a content provider. At 310, if such data is identified, the processor may cause the system to transmit the information to the consumer. At 308, however, if the processor cannot locate the requested data, the method may proceed to 312. At 312, the processor may transmit questions to the user. The answers to the questions may cause the processor to display materials and sites other than the initially requested site. The method may return to 302 after 310 or 312.

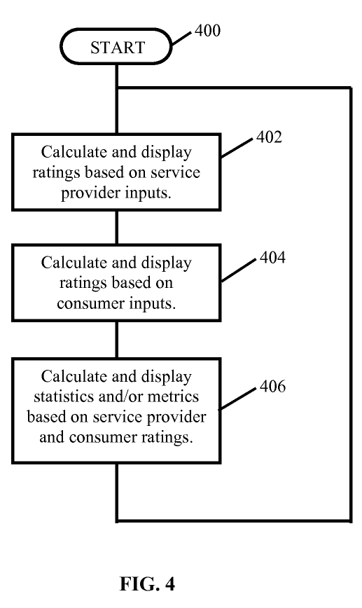

FIG. 4 is a flow diagram of a method rating content in accordance with an embodiment of the invention. The method may begin at 400. At 402, the processor averages the ratings of each given service provider that are provided by other service providers and displays the average rating on a screen of either or both of any service provider or consumer viewing the site of the given service provider. At 404, the processor averages the ratings of each given service provider that are provided by consumers and displays the average rating on a screen of either or both of any service provider or consumer viewing the site of the given service provider. At 406, the processor calculates any or all of a set of predefined statistics or metrics that can be derived from the data obtained in steps 402 and 404 and displays the statistics or metrics a screen of either or both of any service provider or consumer viewing the site of the given service provider. The method loops back upon itself to continuously run through steps 402, 404, and 406. It is noted that 402 and 404 can be performed in parallel, or in series as illustrated.

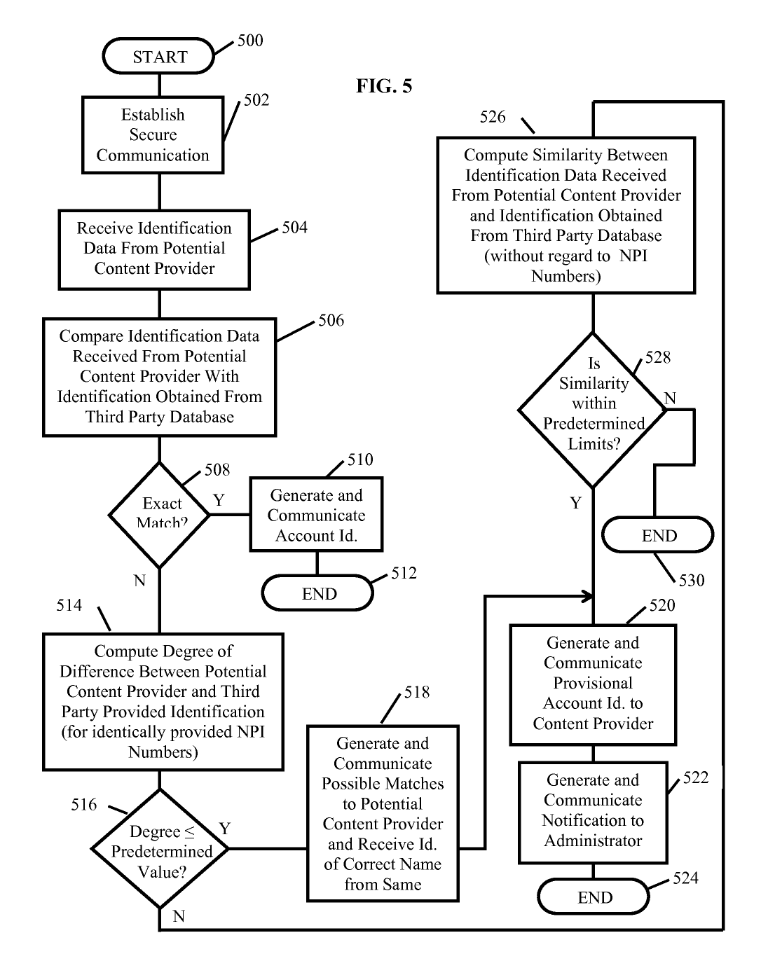

FIG. 5 is a flow diagram of a method of vetting potential content provider credentials according to an embodiment of the invention. The method may begin at 500. At 502, secure communication between a potential content provider and the server may be established. Secure communication may be established using Secure Sockets Layer (SSL) method or any number of communication securing technologies that are available. At 504, the potential content provider's identification may be received. In the exemplary embodiment, the identification data may be the first name, last name, and professional affiliation identification information received by the server from the potential content provider. The professional affiliation identification information may be, for example, a unique identification number given to a professional practitioner by an organization authorized by law or practice to, for example, maintain a roster of, oversee, and/or grant licenses to practitioners of a given field.

In one embodiment, the professional affiliation identification information may be a unique identification number known as the National Provider Identifier (NPI) number. By way of explanation, the Administrative Simplification provisions of the Health Insurance Portability and Accountability Act of 1996 (HIPAA) mandated the adoption of standard unique identifiers for health care providers and health plans. The Centers for Medicare & Medicaid Services (CMS) developed the National Plan and Provider Enumeration System (NPPES) to assign these unique identifiers. The NPI numbers, and data associated with those numbers, are stored in an NPI Registry. In the exemplary embodiment, the NPI Registry (referred to herein as the NPI database) includes physicians' first name, last name, and license number issued to physicians by the United States Department of Health and Human Services. Of course, professional affiliation identification information may be obtained from other sources. The sources may or may not be a national centralized registry. By way of example, the information required to confirm the identity of a given professional might be compiled from multiple sources, such as state databases, professional organization databases, commercial databases, and the like. An entity wishing to practice the system and method of the invention may choose to create its own database, either alternatively to the use of an already existing database, or in addition to one or more already existing databases.

Information in the NPI Registry is updated daily. However, the frequency of updating is not a limitation of the inventive concept. There is no charge to use the NPI Registry. However, the inventive concept is independent of whether an entity practicing the invention would be required to purchase, license or otherwise obtain the right to use any given database.

At 506, a first automated procedure to evaluate and confirm a potential content provider's identity according to an embodiment of the invention may begin. At 506, the processor may compare the information received from a potential content provider to information acquired from the third party database (similar to 122, FIG. 1). While the third party database may be accessed each time a potential content provider's identity is verified, in a preferred embodiment, the contents of the third party database are periodically downloaded to a database (similar to 114, FIG. 1) operated by the entity practicing the invention. Preprocessing of the data downloaded to the database may occur. At 508, if there is an exact match of first name, last name, and unique identification number as between the information received from the potential content provider and the information in the database, the method may proceed to 510. At 510, the processor may generate, and communicate to the potential content provider, an account identifier. The account identifier may be a unique alphanumeric that may be required in order for a content provider to post content on the content provider's page. The method may end at 512. At 508, if there is not an exact match as between first name, last name and unique identifier, the method may proceed to 514.

At 514, a second automated procedure to evaluate and confirm a potential content provider's identity according to an embodiment of the invention may begin. At 514, the processor may compute a degree of difference between the names received from the potential content provider to the names in the database that are associated with the unique identifier received from the potential content provider. At 516, if the degree of difference is less than or equal to a predefined value, then the names are considered similar to each other and the method may proceed to 518.

At 518, the processor may generate and communicate a list of similar names, that is possible matches between the potential content provider and the third party database names, to the potential content provider. The processor may also receive from the potential content provider an identification of the correct name from, for example, the communicated list. At 520, the processor may generate and communicate to the potential content provider a provisional account identifier. The provisional account identifier may be a unique alphanumeric that may be required for a content provider to post content on the content provider's page. At 522, the processor may generate and communicate, for example by e-mail, a message to a system administrator to alert the administrator that a provisional account was generated. The administrator may be required to consider the information provided by the potential content provider and determine whether the provisional account should be converted to a regular account. The administrator may communicate directly or indirectly with the potential content provider, to make any verification necessary to authenticate the identity of a potential content provider and the potential content provider's credentials. The method may end at 524.

At 516, if the degree of difference is greater than a predefined degree, then the names are not considered similar to each other and the method may proceed to 526.

At 526, a third automated procedure to evaluate and confirm a potential content provider's identity according to an embodiment of the invention may begin. At 526, the name entered by a potential content provider may be compared to all of the names in the database to determine a degree of similarity therebetween. The comparison may be conducted regardless of the unique identifier entered by the potential content provider or stored in the third party database. At 528, if the comparison identifies one or more names with a similarity within predetermined limits, then the names are considered similar to each other and the method may proceed to 520.

According to the third automated procedure to evaluate and confirm a potential content provider's identity, the potential content provider may not be presented with a listing of similar names and may not be required to identify the correct name (in contrast to 518, above). The omission of the presentation of a list of similar names may or may not be implemented. At least one reason not to implement the presentation may relate to a need to protect the privacy of the persons identified in the third party database.

At 520, the processor may generate and communicate to the potential content provider a provisional account identifier. The provisional account identifier may be a unique alphanumeric that may be required for a content provider to post content on the content provider's page. At 522, the processor may generate and communicate, for example by e-mail, a message to a system administrator to alert the administrator that a provisional account was generated. The administrator may be required to consider the information provided by the potential content provider and determine whether the provisional account should be converted to a regular account. The administrator may communicate directly or indirectly with the potential content provider, to make any verification necessary to authenticate the identity of a potential content provider and the potential content provider's credentials. The method may end at 524.

Returning to 528, if the comparison does not identify one or more names with a similarity within predetermined limits, then there are no names that are considered similar to each other and the method may end at 530.

In one embodiment, the second automated procedure to evaluate and confirm a potential content provider's identity makes use of the Levenshtein distance algorithm. The Levenshtein distance algorithm is used to quantify the degree of difference between the names. The Levenshtein distance is a metric for measuring the amount of difference between two sequences. The Levenshtein distance between two strings is given by the minimum number of operations needed to transform one string into the other, where an operation is an insertion, deletion, or substitution of a single character. For example, a potential content provider may enter a last name of Jones and a unique identifier number of 12345. At 514, FIG. 5, the processor computes a degree of difference between the name Jones and the last name stored under unique identifier number of 12345 as recorded in the third party database. If the last name in the third party database was Janes, then as shown in the table below, the Levenshtein distance between Jones and Janes is 1. If the last name in the third party database was Jaynes, then as shown in the table below, the Levenshtein distance between Jones and Jaynes is 2. If the last name in the third party database was Jaynzes, then as shown in the table below, the Levenshtein distance between Jones and Jaynzes is 3. The greater the Levenshtein distance is between the name entered by the potential content provider and the name in the third party database, the less likely it is that the two names are referring to the same person.

| | | | | | | | Levenshtein Distance |
|---|---|---|---|---|---|---|---|
| J | o | n | e | s | | | From Jones |
| J | a | n | e | s | | | 1 |
| | | | | | | | 1. substitute A for O |
| J | a | y | n | e | s | | 2 |
| | | | | | | | 1. substitute A for O |
| | | | | | | | 2. insert Y) |
| J | a | y | n | z | e | s | 3 |
| | | | | | | | 1. substitute A for O |
| | | | | | | | 2. insert Y, |
| | | | | | | | 3. insert Z |

In one embodiment, at 516, FIG. 5, if the degree of difference, as measured by the Levenshtein distance, is less than or equal to 2, then the names are considered similar to each other and the method may proceed to 518, FIG. 5. Of course, other methods of determining a degree of difference between the potential content provider's identification information and the identification information stored in the third party database may be used.

In one embodiment, the third automated procedure to evaluate and confirm a potential content provider's identity makes use of a Metaphone algorithm. The Metaphone algorithm is a phonetic algorithm, for indexing words by their English pronunciation. The algorithm, as used in one embodiment, produces a number between 1 and 256 as its output. Similar sounding words share the same number. In one embodiment, at 528, FIG. 5, if the similarity, as indicated by the results of processing the Metaphone algorithm, is sufficiently matched, for example the number used to index the two names is identical, then the names are considered similar to each other and the method may proceed to 520, FIG. 5.

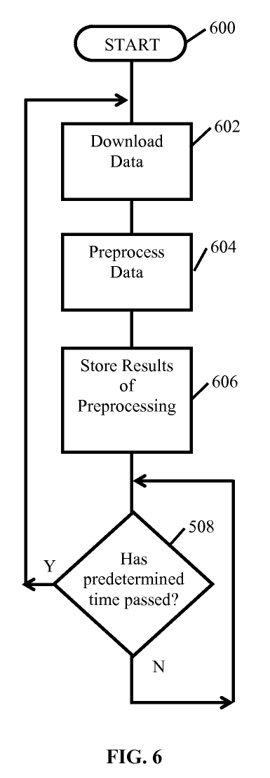

FIG. 6 is a flow diagram of a method of downloading and preprocessing data from a third party database according to an embodiment of the invention. The method may begin at 600. At 602, data from a database comprising professional affiliation identification information may be downloaded to a server (similar to 102, FIG. 1) from a database (similar to 114, FIG. 1) operated by the entity practicing the invention, or downloaded from a remote database (similar to 122, FIG. 1) operated by a third party. At 604, the data may be preprocessed to generate new data useful for the practice of the invention. For example, the data may be preprocessed by the processor (similar to 104, FIG. 1), which may execute commands necessary to perform a metaphase algorithm on selected items of information within the data. At 606, the processor may execute commands to store the results of the preprocessing in a memory (similar to 106, FIG. 1) and/or a database 114 for use at a later time. Preprocessing may provide a benefit of shortening the time it takes the system to verify the identity of a data provider and authorize the opening of a regular or provisional account. At 608, after a predetermined period of time, the process of downloading and preprocessing may be repeated. Accordingly, the system may have, at the ready, any data necessary to verify the identity of a data provider, and may also have, at the ready, at least some additional preprocessed data useful for practicing the invention.

It is noted that the methods of FIGS. 2, 3, 4, 5, and 6 may be performed simultaneously.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A system, comprising:
a server, comprising:
a processor;
a database operationally coupled to the processor;
a memory operationally coupled to the processor;
a communications interface operationally coupled to the processor, wherein the memory stores instructions that, when executed by the processor, cause the server to:
receive, via the communications interface:
a request to store data;
a unique data value representative of an identification of a first content provider; and
multimedia data, associated with the unique data value;
confirm that the content provider identified by the unique data value is a registered content provider;
if the content provider is a registered content provider:
store, in association with the unique data value, the multimedia data;
if the content provider is not a registered content provider:
do not store the received data;

2. The system of claim 1, wherein the processor further executes instructions to cause the server to:
receive, via the communications interface, a request for data associated with the unique data value; and
transmit, via the communications interface, the requested data from the database.

3. A system, comprising:
a server, comprising:
a processor;
a database operationally coupled to the processor;
a memory operationally coupled to the processor;
a communications interface operationally coupled to the processor, wherein the memory stores instructions that, when executed by the processor, cause the server to:
compare identification information provided by a potential content provider with identification information retrieved from a third party database, wherein if the identification information provided by the potential content provider and identification information retrieved from a third party database are identical:
generate an account identifier for the potential content provider.

4. The system of claim 3, wherein the memory stores additional instructions that, when executed by the processor, cause the server to:
compute a degree of difference between the identification information provided by the potential content provider and the identification information retrieved from the third party database, wherein if the degree of difference is less than or equal to a predetermined value:
generate a provisional account identifier for the potential content provider; and
generate a message indicating that the provisional account identifier was generated for the potential content provider.

5. The system of claim 4, wherein the memory stores additional instructions that, when executed by the processor, cause the server to:
generate a list of identification information retrieved from the third party database, wherein the identification information in the list is that identification information that was compared to the identification information provided by the potential content provider, and which had a degree of difference that was less than or equal to the predetermined value.

6. The system of claim 4, wherein the computation of the degree of difference between the identification information provided by the potential content provider and the identification information retrieved from the third party database is performed using a Levenshtein distance algorithm.

7. The system of claim 3, wherein the memory stores additional instructions that, when executed by the processor, cause the server to:
determine a similarity between the identification information provided by the potential content provider and the identification information retrieved from the third party database, wherein if the similarity is within a predetermined limit:
generate a provisional account identifier for the potential content provider; and
generate a message indicating that the provisional account identifier was generated for the potential content provider.

8. The system of claim 7, wherein the determination of the similarity between the identification information provided by the potential content provider and the identification information retrieved from the third party database is based upon the processing of the identification information by a Metaphone algorithm.

9. The system of claim 3, wherein the memory stores additional instructions that, when executed by the processor, cause the server to:
compute a degree of difference between the identification information provided by the potential content provider and the identification information retrieved from the third party database, wherein
if the degree of difference is less than or equal to a predetermined value:
generate a provisional account identifier for the potential content provider; and
generate a message indicating that the provisional account identifier was generated for the potential content provider.
if the degree of difference is greater than the predetermined value:
determine a similarity between the identification information provided by the potential content provider and the identification information retrieved from the third party database, wherein if the similarity is within a predetermined limit:
generate a provisional account identifier for the potential content provider; and
generate a message indicating that the provisional account identifier was generated for the potential content provider.

10. The system of claim 3, wherein the memory stores additional instructions that, when executed by the processor, cause the server to:
display, to a user in a plurality of users, a first value representative of a rating of content of a given content provider, wherein the first value is based on an average of ratings of the given content provider by all other content providers;
display, to the user in the plurality of users, a second value representative of a rating of content of a given content provider, wherein the second value is based on an average of ratings of the given content provider by each user in the plurality of users; and
display, to the user in the plurality of users, a difference between the first and second values.
